(19) United States
(12) Patent Application Publication
(10) Pub. No.: US 2006/0095685 A1
(43) Pub. Date: May 4, 2006

(54) System and method to coordinate access to a sharable data structure using deferred cycles

(76) Inventor: Thomas J. Bonola, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/980,538

(22) Filed: Nov. 3, 2004

(51) Int. Cl. G06F 12/14

(52) U.S. Cl. 711/150

(57) ABSTRACT

In at least some embodiments, a system comprises a plurality of requesters and control logic. The requestors are each capable of accessing a sharable data structure. The control logic causes a request for access to the sharable data structure to be deferred to permit only one requestor at a time to access the sharable data structure.

### BACKGROUND

In some computer systems, multiple requesters (e.g., processors) are permitted access to sharable data structures. To ensure coherency, only one requestor is permitted access to the sharable data structure at a time. In this way, a requestor can read the data structure, modify the data, and write the data back to its original location (e.g., memory), while all other requestors that also want to access the data structure are forced to wait. One of the waiting requesters may then be granted access to the data structure. The mechanism of forcing the other requestors to wait may be implemented as a “spin lock.” In a spin lock, a requestor repeatedly reads a lock flag associated with the data structure. The lock indicates whether the data is “free” or “busy.” The requester repeatedly reads the flag until the flag indicates the data structure is free thereby permitting the requester to access the data. Repeatedly issuing read cycles to read the lock flag undesirably consumes bus bandwidth. The problem is exacerbated as more requestors issue read cycles to read the lock flag associated with a particular lock data structure.

### BRIEF SUMMARY

In at least some embodiments, a system comprises a plurality of requesters and control logic. The requesters are each capable of accessing a sharable data structure. The control logic causes a request for access to the sharable data structure to be deferred to permit only one requestor at a time to access the sharable data structure.

### BRIEF DESCRIPTION OF THE DRAWINGS

For a detailed description of exemplary embodiments of the invention, reference will now be made to the accompanying drawings in which:

FIG. 1 shows a system in accordance with an exemplary embodiment of the invention;

FIG. 2 shows an embodiment of a controller usable in the system of FIG. 1;

FIG. 3 shows an embodiment of a table usable in conjunction with the controller of FIG. 2;

FIG. 4 is a method embodiment of the invention; and

FIG. 5 is a method embodiment related to a timeout feature.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more parts and may be used to refer to a computer system, a portion of a computer system or any other combination of two or more parts.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

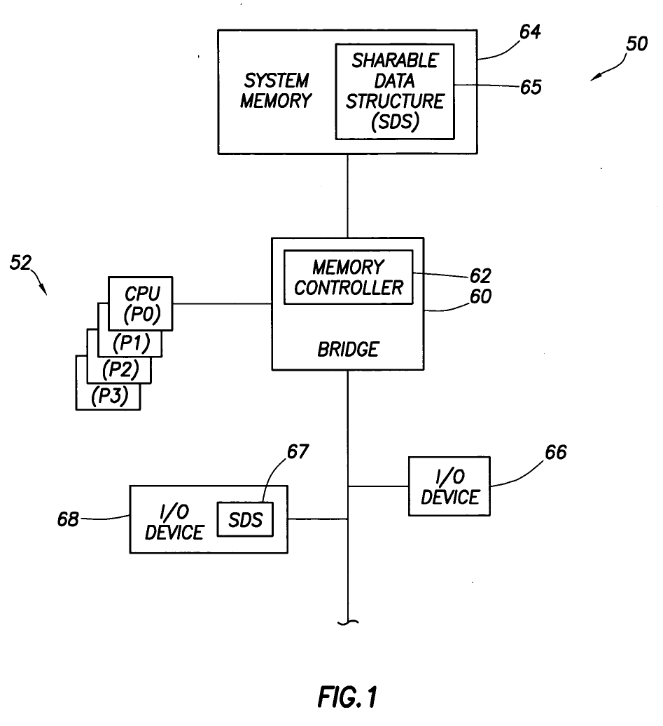

FIG. 1 shows an embodiment of a system 50 comprising a plurality of central processing units (“CPUs”) 52, a bridge 60, system memory 64, and input/output (“I/O”) devices 66 and 68. The CPUs 52, system memory 64, and I/O devices 66 and 68 couple to the bridge 60 in the embodiment of FIG. 1. Different architectures are possible in accordance with other embodiments of the invention. Although four CPUs 52 are shown in FIG. 1, in general, any number (i.e., one or more) of CPUs can be provided. Similarly, any number (i.e., one or more) of I/O devices can be provided as well. The I/O devices can be any type of device. Examples of I/O devices include a network interface controller (“NIC”), storage device (e.g., hard drive, floppy drive, etc.), and video graphics card.

Each CPU 52 can access the system memory 64 or the I/O devices 66, 68 through the bridge 60. The bridge 60 thus functions to coordinate accesses (reads and writes) between the various devices shown in FIG. 1. Thus, a CPU 52 can read from or write to system memory 64. Similarly, an I/O device can read from or write to system memory 64. A CPU can also read from and write to an I/O device. Further still, the bridge 60 can be target of an access request from a CPU 52 or an I/O device 66, 68. The bridge 60 comprises a memory controller 62 to control access to the system memory on behalf of the CPUs 52 and I/O devices 66, 68. In other embodiments, the memory controller 62 can be located apart from the bridge.

Each CPU 52 is assigned an identifier that distinguishes that CPU from the other CPUs. In FIG. 1, the four CPUs 52 are assigned the four identifiers “P0,” “P1,” “P2,” and “P3,” although other identifier types can be used as well. A CPU identifier is the encoded portion of a bus transaction that is used to associate a CPU with a particular bus transaction request. The bridge 60 uses the CPU identifier to route a response message to the correct CPU that initiated the transaction request.

Exemplary embodiments of the invention provide for control of access to one or more sharable data structures. In FIG. 1, a sharable data structure 65 is illustrated as stored in system memory 64. A sharable data structure 67 is also illustrated in I/O device 68. Any number of sharable data structures can be provided as desired and one or more sharable data structures can be included in any suitable system device such as those shown in FIG. 1. A sharable data structure is any type of data structure that is sharable between two or more requestors that may request access to the sharable data structure for read and/or write purposes. In the embodiment of FIG. 1, requester may be a CPU 52 or an I/O device 66, 68. A sharable data structure in the context of this disclosure is accessed by only one requestor at a time. Thus, if two or more requestors attempt to simultaneously access the same data structure, only one requestor will be granted access and the other competing requesters will be forced to wait for the data structure to be free for subsequent access by another requestor.

The embodiments described herein implement a deferred cycle mechanism to control access to a sharable data structure (e.g., data structures 65 or 67). Access to a sharable data structure generally involves both software and hardware. For example, a device driver or operating system kernel may require access to a sharable data structure and the controller (e.g., controller 62) responds to the request. In at least some embodiments, the software may implement any suitable “spin lock” mechanism that comprises a control loop which, when executed, repeatedly reads a spin lock variable (in at least some contexts referred to as a “spin lock flag”) to determine whether the associated sharable data structure is free or busy. In response to an access to the lock variable, the controller implements a deferred cycle mechanism in which the controller issues a deferred-reply message to the requesting agent (e.g., a CPU 52) which indicates to the requesting agent that the requested information is not yet ready. At that point, the software's spin lock loop running on the requestor is caused to stop execution until the controller responds again that the requested lock variable is available. The controller, however, does not respond again until the lock variable is free. Thus, the software's spin lock loop always, in at least some embodiments, upon execution of the first spin lock variable access in the loop results in an indication that the sharable data structure is free. In this manner, the requesting agent generally will not have to repeatedly read the lock variable, reducing memory bandwidth consumption due to write-back cache activity to keep the lock variable consistent between CPUs. The software need not implement a spin lock, but software that already exists with spin locks implemented therein will function correctly with the hardware's deferred reply mechanism without requiring modifications to the software. In short, the software can implement a spin lock, but the hardware implements a deferred cycle mechanism to coordinate access to a sharable data structure. The following description explains the hardware's deferred cycle mechanism.

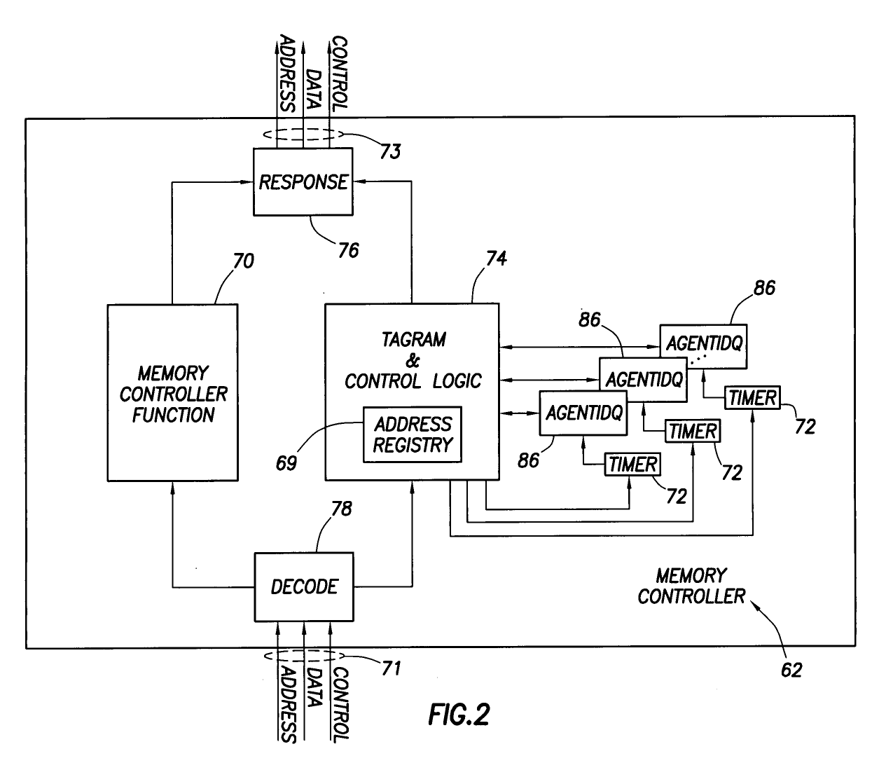

FIG. 2 shows an embodiment of memory controller 62 as comprising memory controller function 70, tag random access memory (“TAGRAM”) and control logic 74, response logic 76, and decode logic 78. The memory controller 62 may also comprise one or more agent identifier queues (“AGENTIDQ”) 86. A timer 72 may be associated with each AGENTIDQ 86. The memory controller receives memory requests via signals 71, which comprise address, data, and control signals. The memory request may include read and write requests. The decode logic 78 determines the type of memory access and forwards the access to both the memory controller function 70 and the TAGRAM and control logic 74. The memory controller function 70 performs any one of the variety of standard memory controller functions such as arbitrating for access to the memory 64 when multiple memory requests are currently pending. The memory controller function 70 forwards the memory accesses to the system memory 64 via the response logic 76 which asserts corresponding address, data, and control signals 73. The deferred reply messages noted above are transmitted by the controller 62 via signals 71 back to a requestor (e.g., a CPU).

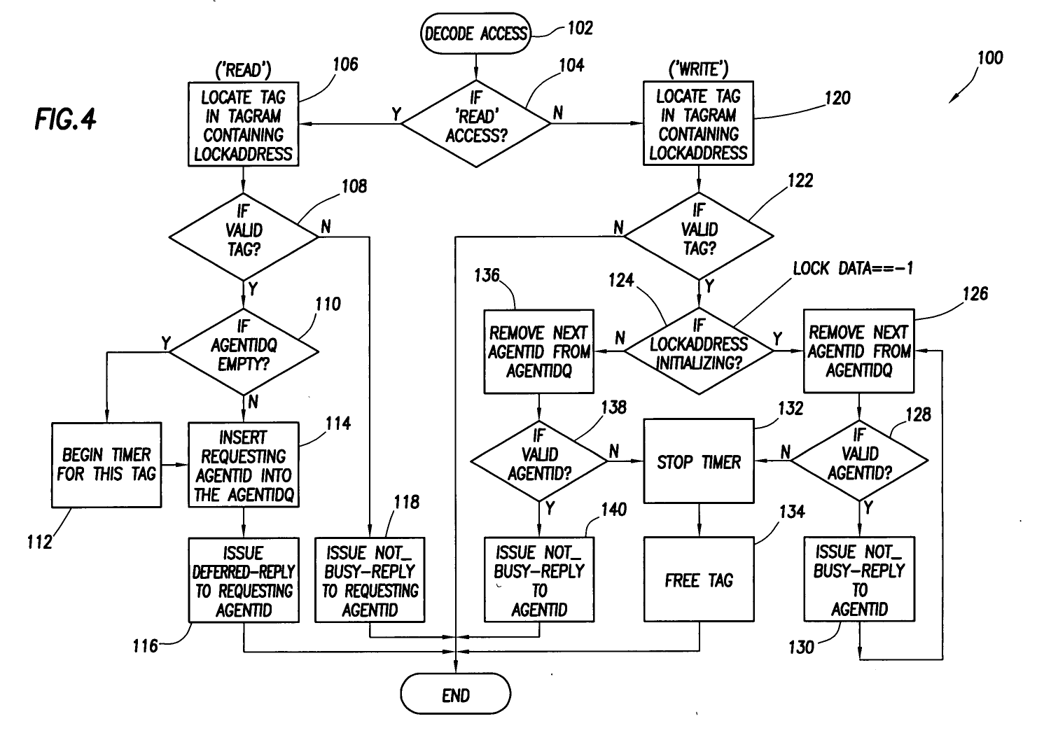

The TAGRAM and control logic 74 comprises logic which implements one or more of the features described herein for implementing a spinlock. FIG. 4 will be described below and includes a flow chart of functions many or all of which may be performed by the TAGRAM and control logic 74 as will be discussed below with respect to the discussion of FIG. 4.

The embodiments described below refer to the actions performed by the memory controller 62, although other types of controllers including controllers that are not memory controllers per se can be used as well. In general, any controller that can be configured to implement a deferred cycle to control access to sharable data structures can be used.

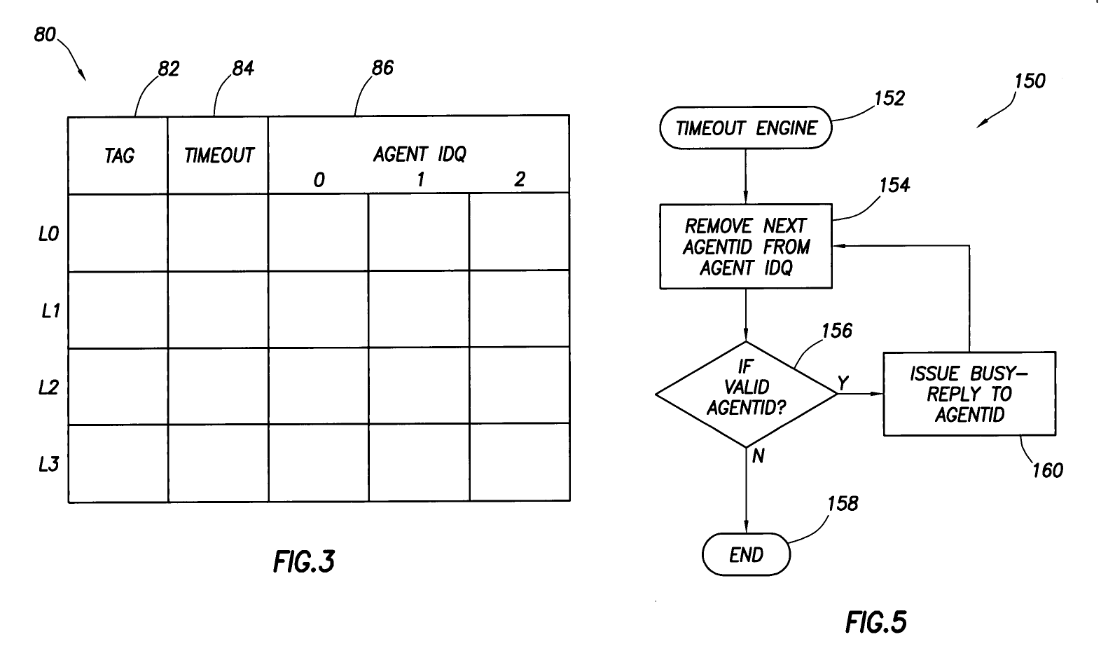

FIG. 3 shows a table 80 that is managed by the controller 62. The table includes one or more entries for one or more lock variables. Four lock variables L0 through L3 are illustrated in FIG. 3. For each lock variable, a “tag” field 82, a timeout field TO 84, and an agent identifier (“ID”) queue 86 are provided. The use of fields 82, 84, and field 86 will be explained below in more detail. In general, each entry in table 80 is used to store information about a lock variable. The information is used to control access to a sharable data structure associated with each lock variable. The tag field 82 may include the address of the lock variable or a portion of the address of the lock variable and generally comprises a value that identifies the lock variable to a particular sharable data structure. In some embodiments, a block of memory space is allocated to hold the lock variables, in which case the tag identifies which location in the block represents each lock variable. This allocated block of memory space can be at a fixed location or can be specified by a base register that is initialized by the operating system. Control logic 74 includes an address decoder to identify an access within the block. Alternatively, if the entire address of each lock variable is included in the tag, then each lock variable may be located at any location in the memory space, as permitted by the operating system.

The timeout field 84 is used to control a timer 72 associated with the lock variable. The timeout field 84 may comprise one or more bits. In some embodiments, a value of zero for the timeout field 84 disables the timer 72 and in other embodiments, other values disable the timer. A non-zero value is a threshold value for a timer state machine to execute to employ the agent ID queue 86 as will be explained below. The agent ID queue 86 is used to store identifiers associated with one or more requestors that are awaiting access to the associated sharable data structures.

The number of lock variables is set in accordance with user needs. Further, the number of AGENTIDQs 86 is set depending on the number of requesters. For example, because there can be at most three waiters in a four-requestor system, then only three AGENTIDQs are needed. Thus, in at least some embodiments, the number of AGENTIDQs is one less than the number of potential requesters.

The use of the controller 62 to control access to a shared data structure using a deferred cycle mechanism will now be described with regard to the exemplary method 100 depicted in FIG. 4. In describing FIG. 4, reference will also be made to the embodiments of FIGS. 1-3. Some or all of the functionality depicted in FIG. 4 is performed by the controller 62. Method 100 begins at 102 in which an access to a lock variable is decoded, for example, by decode logic within control logic 74. In some embodiments of the invention, the access may be in the form of a software-based spin lock access to a lock variable (e.g., L0-L3). As explained above, in a spin lock access, software includes instructions that if executed, would repeatedly check the lock variable to detect when the variable is “available” (a state alternatively referred to as “free” or “not busy”) as opposed to “busy” which indicates that another requestor has access to the sharable data structure associated with the lock variable. In accordance with an embodiment of the inventor, CPU 52 executing software containing such a spin lock, will generally not execute more than one request for the lock variable the controller 62 defers the requester for the lock variable access as described herein. The lock variable access is decoded at block 102 as a “read” or as a “write.” A read access comprises an attempt by a requestor to determine the state of the lock variable to ascertain whether the associated shared data structure is available for access by the requestor. A write access is an attempt by a requestor that currently has ownership of the lock variable, and thus access to the associated data structure, to release the lock variable from its current “busy” state to the “not busy” state. The “not busy” state indicates that the sharable data structure is available for access by another requestor.

Block 102 may be performed by the controller 62 decoding the lock variable access. With regard to the memory controller embodiment of FIG. 2, the decode logic within control logic 74 decodes the lock variable access. If, at decision block 104, the lock variable access is decoded as a read, the functions of blocks 106-118 are performed. At block 106, the controller examines the table 80 to determine if the tag associated with the target lock variable is present. If the tag is not present in the table 80, then the associated shared data structure is considered “not busy” and thus available for access by the requestor that issued the lock variable access. This determination is performed as indicated by decision block 108. If the target tag is not valid, then the function of block 118 is performed in which the controller 62 issues a “not busy” reply to the requesting agent ID of the requester and the previously invalid tag is set to valid to indicate that the lock variable is now busy.

If, however, the target tag is valid, which indicates that the sharable data structure is being accessed by another requestor, then the controller 62 determines if the agent ID queue 86 associated with the target lock variable is empty. If the associated agent ID queue 86 is not empty (i.e., there is at least one agent ID in the queue 86), then the agent ID of the requestor is inserted into the agent ID queue (block 114). If the agent ID queue 86 is empty, then, in addition to inserting the agent ID into the queue 86 (block 114), the timer 74 associated with the lock variable is caused to begin counting for that particular lock variable (block 112). The timer 74 begins counting towards its terminal count value (e.g., 0 if counting down or a non-zero number if counting up from 0). The timer is reset when the lock variable is released by the requestor (i.e., the requestor no longer needs access to the associated shared data structure). If the timer reaches its terminal count value, then all entities awaiting access to the lock variable (“waiters”), as indicated by their agent IDs, are removed from the associated agent ID queue 86 and issued a “busy” reply to cause the software spin lock acquire algorithm to retry its attempt to claim lock ownership. After inserting the agent ID of the requester in the agent ID queue 86, the controller 62 issues a deferred-reply message to the requester (block 116). This message indicates that another requester currently has control of the lock variable and thus access to the requested sharable data structure, and that the controller will again contact the requestor when the sharable data structure becomes available, or if the timer 74 expires indicating that the sharable data structure is still unavailable. The requestor receives the deferred reply which precludes the software process that issued the read (106) from continuing to run until subsequently receiving the requested data. The data will subsequently be provided to the requestor when the requestor is given control of the associated lock variable which will occur when the lock variable becomes available and the waiting requestor is next in the agent ID queue awaiting access to the lock variable. Essentially, the requestor issues a read request for a lock variable and the read request is not permitted by the controller to complete until the requested data is available. From the requestor's perspective, the requester issues a read request and the data is returned, albeit possibly after a delay while the controller coordinates access to the requested data.

If, at decision block 104, the lock variable access is decoded as a write (which indicates that the requester that currently has access to the lock variable and no longer needs access to the sharable data structure), the functions of blocks 120-140 are performed as described below. At block 120, the controller 62 examines the decode information 80 to determine if the tag associated with the target lock variable is present in tag field 82. If the tag is not present in table 80, then the process ends. If the target tag is present in the tag field 82 of the associated lock variable, then at 126 the controller 62 determines if the lock address is initializing. Initializing the lock variable comprises the software act of placing the lock variable into a known “free” state and ensuring that there are no waiters in the agent ID queue. If the lock address is initializing, the next agent ID is removed from the agent ID queue 86 (block 126) and, per decision 128, if that next agent ID is valid, the controller 62 issues a “not busy” reply message to the requestor associated with the next agent ID (block 130) removed from the agent ID queue and control loops back to block 126. If the next agent ID is not valid, as determined by decision 128, the timer 74 associated with the lock variable is stopped at block 132 and the tag is freed at block 134.

If, at decision 124, the lock address is not initializing, the next agent ID is removed from the agent ID queue (block 136) and the controller 62 further determines, at block 138, whether that next agent ID is valid. If the next agent ID is not valid, the timer 74 is stopped (block 132) and the tag is freed (block 134). If the next agent ID is valid, then the controller 62 issues a “not busy” reply to the requestor associated with the next agent ID (block 140) removed from the agent ID queue and the process ends.

FIG. 5 illustrates a method embodiment 150 related to the use of a timeout in conjunction with the deferred reply mechanism described above. The embodiment 150 of FIG. 5 may be a state machine for controlling the timeout function. The timer 72 is set to zero (disabled) by hardware (controller 62) at system initialization and may be changed to a non-zero threshold value by software when desired. In some embodiments, the time for a lock variable is caused to count during a lock request. When a timeout occurs, the current access (that has timed out) is terminated so any waiting requestors are given an opportunity for access to the lock variable. Method 150 may be performed upon expiration of the timer and describes what happens after terminating the current access. The purpose of the timeout is to prevent starvation by requestors that are requesting access to a sharable data structure. Method 150 is performed by controller 62. Method 150 begins at block 152 and comprises removing an agent ID from the agent ID queue 86 (block 154). The controller 62 then determines at decision 156 whether the agent ID is valid. If the agent ID is not valid, the process ends at 158. Otherwise, if the agent ID is valid, block 160 is performed in which the controller issues a “busy” reply to the requestor associated with the agent ID and control loops back to block 154 to remove the next agent ID from the queue 86. The timer mechanism keeps the system operational by mitigating a potential deadlock condition due to the abnormal termination of the agent ID that is the current lock owner. Timer expiration ensures all waiters (agent IDs) are replied to within a bounded time period so that software has a chance to implement back off and deadlock avoidance algorithms.

Access to some shared data structures can be controlled by a deferred cycle mechanism such as that described above. Access to other shared data structures instead can be controlled via a conventional spin lock mechanism in which a requester repeatedly reads a lock variable to determine if the shared data structure is available. If desired, access to all shared data structures can be controlled by the disclosed deferred cycle mechanism. Identification of the data structures that are susceptible to control via the deferred cycle mechanism and those that are susceptible to control via a spin lock mechanism can be hard-coded or programmable. For example, the memory controller 62 shown in FIG. 2 shows an address registry 69 which is used to register address of lock variables that are used in conjunction with the deferred-reply mechanism described above. As such, when an access to a lock variable is requested, that access is processed according the deferred-reply mechanism of FIG. 4 if the lock variable is included in registry 69. If the lock variable address is not stored in registry 69, then the disclosed deferred-reply mechanism is not used to control access to the underlying data structure.

At least some embodiments of the invention function with software that implements atomic or non-atomic software instructions to acquire the lock and access the shared data structure. An exemplary portion of software that does not use atomic instructions to acquire the lock is provided as follows:
Acquire: mov eax, lock; read the value of the lock variable into register eax.
   cmp eax, busy; compare the lock variable to a busy indicator to determine if lock is in the busy state.
   je acquire; loop back to the Acquire flag if the lock variable is busy.
      Then, to release the lock variable, as explained previously, the software performs a write cycle to the lock variable such as with the following instruction:
Release: mov lock, free; writes the lock state free to the lock variable.

Software having atomic instructions can be used as well as with memory controller described herein. At least some atomic instructions, such as atomic read-modify-write or “bit test set” instructions, include a write cycle as part of the atomic instruction's execution. In an embodiment of the invention, this write cycle is ignored. With reference to FIG. 4, when the write cycle of the atomic instruction is encountered, that write cycle is not processed through block 120 in the right-hand side of the flowchart of method 100—otherwise, a conflict would occur when the subsequent release write instruction (see above) is subsequently executed.

A predefined number of deferred cycles may be outstanding at any point in time. If more than that number is exceeded, in at least some embodiments the oldest pending memory accesses may be continued using a spin lock mechanism (repeatedly checking the lock status), rather than using the disclosed deferred cycle mechanism (waiting on the memory controller to release the lock to the requester).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of requesters, each capable of accessing a sharable data structure; and
control logic coupled to said requesters, said controller causes a request for access to the sharable data structure to be deferred to coordinate access to said sharable data structure to permit only one requestor at a time to access said sharable data structure.

2. The system of claim 1 wherein said controller receives a read request from a requestor for a lock variable associated with said sharable data structure and grants exclusive access to said sharable data structure if said lock variable is not at a state indicative of another requester already having exclusive access to said associated sharable data structure.

3. The system of claim 2 wherein said controller issues a deferred reply if said lock variable is at a state indicative of another requestor having exclusive access to said sharable data structure, said deferred reply causing said requestor to cease requesting access to said sharable data structure and to wait for said controller to indicate that the sharable data structure is available to the requestor.

4. The system of claim 3 wherein said controller has access to a queue for said lock variable, said queue adapted to confirm identifiers associated with one or more requestors being deferred access to said sharable data structure.

5. The system of claim 3 wherein said controller comprises a timer associated with said lock variable, said controller initializing said timer when a requestor's identifier is stored in said queue, and if said timer reaches a predetermined terminal value before said variable is released by a current requestor, the controller removes the requestor's identifier from said queue and issues a message to said requestor indicating that another requestor has exclusive access to said sharable data structure.

6. The system of claim 1 wherein said controller comprises a timer that, upon expiration of the timer while a requestor has access to the sharable data structure, causes a requestor that is awaiting access to the sharable data structure to be removed from a waiting state and issued a busy reply message.

7. The system of claim 1 wherein said controller comprises a memory controller.

8. The system of claim 1 wherein each requestor comprises a central processing unit.

9. The system of claim 1 wherein at least one of the requestors comprises a control processing unit that executes code, said code containing instructions that comprise an atomic access to obtain access to said sharable data structure and said control logic issues deferred cycles in response to said spin lock instructions, and wherein the atomic access has a write portion and the write portion of the atomic access is ignored.

10. A system, comprising:
means for receiving spin lock requests for access to lock variable associated with a sharable data structure; and
means for performing deferred transactions to control access to the sharable data structure.

11. The system of claim 10 further comprising means for causing a requester for said sharable data structure that is awaiting access to the sharable data structure to be removed from a waiting state and issued a busy reply message if a timer expires while another requestor has access to the sharable data structure.

12. A controller comprising:
decode logic adapted to decode requests from each of a plurality of requestors for access to a spin lock flag and;
control logic that causes a reply to be sent to a requestor that requests access to the spin lock flag, the reply causes the requestor to be deferred until the requested spin lock flag is free for use by the requester.

13. The controller of claim 12 further comprising a timer adapted to cause, upon expiration of the timer while a requestor is accessing the sharable data structure, a requester that is awaiting access to the sharable data structure associated with the spin lock flag to be removed from a waiting queue.

14. A method, comprising:
receiving an access for a spin lock variable from a requesting agent; and
if said access is a read access, deferring an access to a data structure associated with said spin lock variable if said spin lock variable is at a lock state that indicates that the data structure is currently permitted access by another requesting agent.

15. The method of claim 14 further comprising decoding said received access as a read access or a write access.

16. The method of claim 14 wherein if said received access is a write access, setting said spin lock variable to a free state to permit access by a requesting agent to said data structure.

17. The method of claim 14 wherein if said received access is a read access and said spin lock variable is at the spin lock state, storing an identifier of the agent that issues said spin lock variable access to a queue to await access to said data structure.

18. The method of claim 14 further comprising issuing a reply granting the agent that issued the access for the spin lock variable access to the data structure.

19. The method of claim 14 wherein, if an agent is listed in a waiting queue while awaiting access to the data structure, removing the agent from the waiting queue upon expiration of a timeout timer.
